(19) United States
(12) Patent Application Publication
(10) Pub. No.: US 2012/0192076 A1
(43) Pub. Date: Jul. 26, 2012

(54) Event Notification System for Residential and Commercial Buildings

(76) Inventor: Jonathan Rocca, Woodbridge (CA)

(21) Appl. No.: 13/305,162

(22) Filed: Nov. 28, 2011

Related U.S. Application Data
(60) Provisional application No. 61/436,428, filed on Jan. 26, 2011.

(51) Int. Cl. G06F 3/01

(52) U.S. Cl. 715/738

(57) ABSTRACT

An event notification system for residential and commercial buildings. The system comprises at least one operator terminal and a plurality of user terminals throughout the building. Each suite or unit of the building has a user terminal removably secured in a prominent location on a wall. The user terminal has a touch screen for easy navigation of the user interface. This user interface provides a variety of selectable tasks and notification messages associated therewith. Notification messages are sent by building management to any individual, subset or group of user terminals to inform tenants of updates. Tenants have the option of responding to some notifications to provide management with comments and suggestions. In this way, the event notification system facilitates timely and effective communication between building management and tenants.

### CROSS REFERENCE TO RELATED APPLICATION

This application claims the benefit of U.S. Provisional Application No. 61/436,428 filed on Jan. 26, 2011, entitled “MYnotice.”

### BACKGROUND OF THE INVENTION

1. Field of the Invention

The present invention relates to a building management and communications tool. More specifically, it relates to an event notification system providing means for bi-directional communication between building management and individual tenants.

Building managers have long faced the problem of devising effective ways to inform tenants about important updates. Some updates are intended to put tenants on notice of upcoming actions such as building maintenance, policy changes or changes to office hours. Other updates alert tenants of opportunities such as building sponsored social events or special offers. Management personnel often resort to the use of paper flyers stuffed into mailboxes or attached to a door. These methods of information dispersal are not generally effective because the flyers are tossed out as junk mail, lost or misplaced prior to being read by a tenant. In addition, the volume of paper used to create such notifications can be large, resulting in a considerable waste of paper and resources.

The communication conundrum is further complicated when notifications solicit a response from tenants. For example, an event notification may request that tenants RSVP so that management knows how many desserts to order. A condo community may request that members submit a vote for new members to the condo association board. Building maintenance notifications can state that tenants must respond with a desired time for maintenance to be performed on their unit. In most building communities, response to these types of notifications requires the tenant to either call management personnel to submit a written reply or visit the management office. Each of these options can be time consuming and inconvenient for busy tenants with limited time to schedule such actions. An effective, low waste system is needed for providing building management with a means to communicate with tenants.

2. Description of the Prior Art

The prior art contains a variety of event notification systems for providing a user having a touchscreen interface with a variety of notifications. These devices have familiar design and structural elements for the purposes of providing emergency alerts and information; however they are not adapted for the task of facilitating bi-directional communication between managers of a residential or commercial building and their tenants.

Dahl et al, U.S. Pat. No. 7,719,415 discloses a building monitoring system having a kiosk or access point located outside of a building. The access point comprises a touch screen display, a computer system, and a means of communication with a plurality of building monitoring systems. The touch screen interface allows emergency response personnel to perform the following functions at the kiosk: 1) zoom into a detailed map of the emergency site; 2) turn on and control any available CCTV cameras in the immediate area; 3) revert to a previously stored set of images of the emergency site if power has been cut to the CCTV camera or they have been destroyed; 4) place a measurement overlay on the previously stored images to determine distances, door or window opening sizes, hallway widths and heights, room dimensions and the like; 5) monitor input from any networked security sensor or electromechanical safety device; 6) disable or silence alarms or electromechanical devices; 7) download any stored information from an internal security station to a laptop or storage device with the proper access password; and 8) use the device as an intercommunications protocol gateway, to distribute building information to cell phones, police radios or other emergency responders.

The Dahl system is intended to provide emergency personnel with readily available information regarding the structure of, and current activity within, a building. Dahl does not disclose a plurality of user terminals. Nor does Dahl disclose each unit in a building having one touch-screen user terminal. The system of Dahl does not contemplate transmission of individualized documents, spreadsheets, presentations, or the like to residents within the building. Nor does Dahl contemplate the ability of a system administrator to obtain read receipts for transmissions sent to the access points. The present system disseminates information to residents of a building, not first responders. The present system also permits users to respond to notifications unlike the system of Dahl, which merely permits viewing of notices.

Valencia et al, U.S. Pat. No. 6,688,518 discloses a wall mounted touch screen information system. The information system comprises a housing and front cover. Enclosed within or attached to the housing is a computer, a touch-screen display, a CCD camera, a card reading means, a spool printer, a network connection, a CD drive, and a telephone. The access points are placed in jails, courthouses and other areas where access to legal services, court services and the like, are desired. The touch-screen interface allows a user to search for legal advice, court documents, court filings, bond services, and such. The user may select the desired services and, if payment is required, a credit card may be inserted. Camera and telephone peripherals are used to interact with service providers. This system does not disclose access points distributed amongst the residences in a building. Valencia does not contemplate a system that permits a user to view a variety of file types. Nor does Valencia disclose a read receipt viewable by a system administrator after end users read transmissions.

Dawes et al, U.S. Patent Publication No. 2009/0,070,682 discloses a security system comprising a computer, a touch-screen, a local area network (LAN), and a server. The touch-screen monitor is operatively connected to the computer, which communicates with a LAN. A user may interact with the security system through the touch-screen interface. The interface provides access to premise monitoring systems such as cameras, intrusion detection devices, and thermostats. Additionally the interface connects to the remote server to provide the security company with information regarding the user's premises. A user may utilize the touch-screen to obtain a variety of information such as news, weather and to search the Internet. Alarm buttons are disposed at the bottom of the touch-screen interface so that a user may quickly alert an operator in the event of an emergency. Dawes et al, does not disclose an event notification system for providing information to residents of a community. The present invention provides a system administrator with means for transmitting event schedules, building updates, policies and the like. Additionally the present invention provides a user with the ability to request access to amenities and RSVP to events. Dawes does not disclose these functional capabilities.

Arnone et al, U.S. Patent Application Publication No. 2004/0162880 discloses an alert notification system for use in financial management systems. The system comprises a mainframe, at least one alert routing server, a web application server and at least one user computer. Alerts are generated at the mainframe and transmitted to the alert routing servers to determine what type of message is being sent and to what part of the web application server the message should be sent. The application server then determines what users should receive the alert. When a user starts up the client side of the system, the user is authenticated via one-way hashing. Once the user is registered with the system, messages for that user are transmitted to the client computer. Arnone describes a system that provides financial market alerts and notifications to financial management professionals. The system of Arnone does not contemplate coordination of shared amenities. It does not disclose the use of the system to facilitate communication of notifications between a building manager and the tenants. The present event notification system contemplates a variety of options that pertain to common activities associated with property management, it does not relate to secure transaction of financial market alerts.

The devices disclosed by the prior art do not address the need for facilitating regular bi-directional communication between the managers of a building and the tenants. The current invention relates to a device for facilitating paperless communication between building managers and tenants. It substantially diverges in elements from the prior art; consequently it is clear that there is a need in the art for an improvement to the known types of event notification systems. In this regard the instant invention substantially fulfills these needs.

### SUMMARY OF THE INVENTION

In view of the foregoing disadvantages inherent in the known types of event notification systems now present in the prior art, the present invention provides new event coordination and response capabilities wherein the same can be utilized for providing convenience for the user when communicating with building tenants or management.

The system utilizes a plurality of user terminals in communication with an operator terminal via a local area network (LAN), to provide a variety of communication options to building tenants. Building management can send messages, notifications and other updates to the user terminals by means of an operator terminal. The operator terminal may be any personal computing device such as a desktop, laptop or the like. Notifications are generated at the operator terminal by inputting event details into a system management application. After the notification message is created, it is transmitted to the user terminals and is ready for viewing.

The user terminals are portable computing devices such as tablet PCs that are removably docked within a recess in each residence or unit. User terminals receive notifications from building management, and display a notification alert screen to indicate that unread correspondence is available for viewing. High visibility areas are ideal for placement of the terminals, to ensure that notifications are read in a timely manner.

The user terminal has a touchscreen monitor to minimize the need for input peripherals, which can be lost or damaged. When a tenant presses the screen of the terminal device, a user interface is displayed. A default welcome screen provides tenants with several selectable options including: 1) event notifications; 2) amenities; 3) building policies; 4) emergency information; 5) realty options; 6) voting options; and 7) language selection. Pressing an on-screen button results in a screen change that reflects the selected option.

When selected, some options require a response or RSVP. A simple RSVP may prompt a user to press a button associated with “yes”, “no” or “maybe”, while other responses may require textual input. This submission is transmitted to the operator terminal, where response tallies may be stored. Other selectable options provide a variety of presented files such as a slideshow presentation that addresses changes to a facility policy. When messages are read or replied to, a read receipt is sent to a system administrator. These receipts help a system administrator maintain a record of tenants who have read policy changes.

The system therefore provides a means for bi-directional communication between building management and tenants. Unlike paper flyers that can become lost in the mail or tossed in the waste bin, the user terminals are sturdy and mounted in the wall to make them easy to locate. By utilizing in-unit terminals that are easily viewable and non-disposable the system increases the probability that users will read building notifications. The system provides tenants with means to easily respond to management inquiries without making phone calls, stopping by an office or logging onto a computer to send an email. In this manner, the invention seeks to improve the flow of communication between building management and tenants, and to reduce the volume of wasted paper.

It is therefore an object of the present invention to provide a new and improved event notification system having all of the advantages of the prior art and none of the disadvantages.

Another object of the present invention is to provide a new and improved event notification system having user terminals in each unit within a building.

Yet another object of the present invention is to provide a new and improved event notification system wherein the tenant terminals are mobile, to permit a user to review notifications in a place of the user's choosing.

Still another object of the present invention is to provide a new and improved event notification system that allows tenants to easily respond to notifications by making an appropriate on-screen selection at a user terminal.

A further object of the present invention is to provide a new and improved event notification system that allows tenants to vote on proposed issues, committee members and the like, without submitting paper ballots.

A still further object of the present invention is to provide a new and improved event notification system that gives building tenants access to emergency policies and exit maps at all times.

Another object of the present invention is to provide a new and improved event notification system that improves the flow of communication between building management and tenants.

Yet another object of the present invention is to provide a new and improved event notification system that sends read-receipt to a system administrator when a tenant views a notification.

Still another object of the present invention is to provide a new and improved event notification system having easily replaceable user terminals.

A further object of the present invention is to provide a new and improved event notification system that may be implemented on a closed internal network, utilizing a software-based message server, to reduce the complexity and cost of system implementation.

A yet further object of the present invention is to provide a new and improved event notification system that reduces the volume of paper used for building notifications.

A still further object of the present invention is to provide a new and improved event notification system having terminals of durable and resilient construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1A shows a block diagram of a preferred embodiment of the present event notification system.

FIG. 1B shows a block diagram of an alternative embodiment of the present event notification system.

FIG. 2 shows an exemplary embodiment of a welcome screen of the present event notification system.

FIG. 3A shows a front view of an exemplary embodiment of a notification interface screen of the present event notification system. This screen provides a user with a selection of available event notifications to view.

FIG. 3B shows a front view of an exemplary embodiment of an individual event notification screen of the present event notification system. This screen provides information regarding a specific event.

FIG. 3C shows a front view of an exemplary embodiment of a notification response interface screen of the present event notification system. The keyboard provides a user with a textual input means so that users may generate customized responses to notifications.

FIG. 3D shows a front view of an exemplary embodiment of a building amenities reservation request screen of the present event notification system. This screen provides the ability to reserve building amenities for specific dates and times.

FIG. 3E shows a front view of an exemplary embodiment of a voting ballot interface screen of the present event notification system. This screen provides an electronic ballot for a solicited vote.

FIG. 3F shows a front view of an exemplary embodiment of a new message alert screen of the present event notification system. This screen is displayed when a new notification is ready for viewing.

FIG. 4A shows a perspective view of a preferred embodiment of the user terminal of the present event notification system, removed from a docking recess.

FIG. 4B shows a perspective view of a preferred embodiment of the user terminal of the present event notification system, inserted into a docking recess.

### DETAILED DESCRIPTION OF THE INVENTION

Reference is made herein to the attached drawings. Like reference numerals are used throughout the drawings to depict like or similar elements of the event notification system. For the purposes of presenting a brief and clear description of the present invention, the preferred embodiment will be discussed as used for facilitating communication between building management and the tenants of a building. This is for representative purposes only and should not be considered to be limiting in any respect.

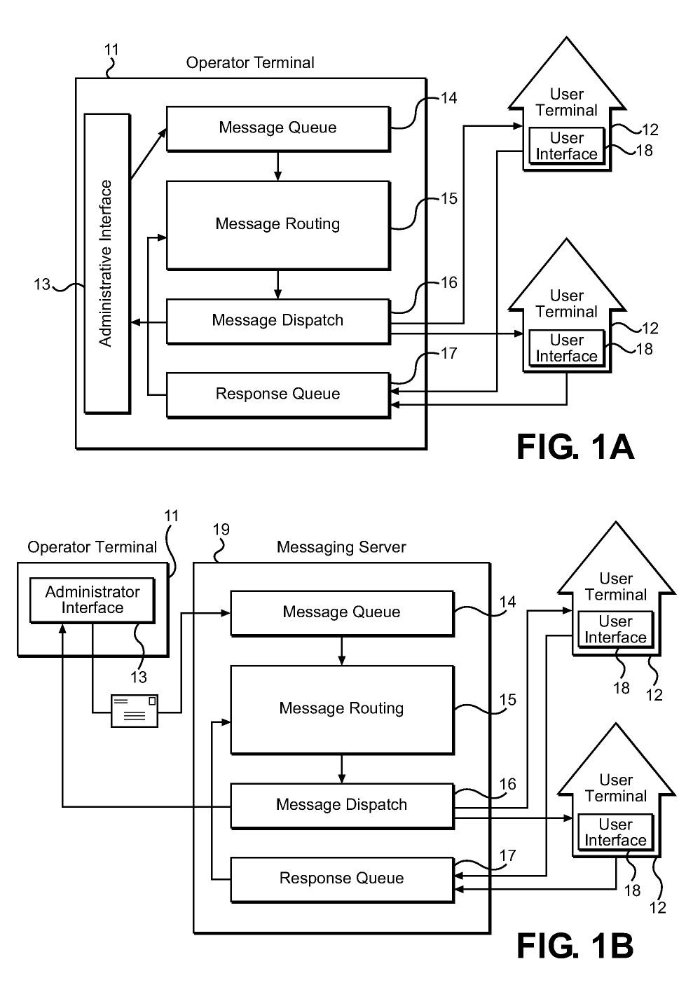

Referring now to FIG. 1, there is shown a block diagram of the event notification system. The system comprises an operator terminal 11 and a plurality of user terminals 12. A system management application is installed on the operator terminal to provide message-handling functionality. This application includes an administrator interface 13, a message queue 14, a message routing element 15, a message dispatch 16 and a response queue 17. Notification messages are created at the administrator interface, sent to the message queue, sorted by the message routing element then sent to the user terminals by the message dispatch. Response messages are created by a user interface 18 installed on a user terminal, returned from the user terminals to the response queue, then sorted by message routing and sent by the message dispatch to the operator terminal. The system thus provides bi-directional communication between an administrator and individual users.

Building management personnel can use the administrator interface 13 to create, receive and track notifications. When a new notification is generated, the administrator interface prompts the administrator to input information about the type of notification, details to be included, whether a response is requested and whether the administrator would like a read-receipt. The administrator then selects the intended recipients and submits the message. Sent messages may be tracked using the read-receipt capability, which allows an administrator to see whether individual users have viewed a notification. The administrator interface may be able to sort these receipts into lists so that building management can quickly view a visual representation of how many users have viewed a sent notification. Further tracking functionality may be provided by a “status” indicator that designates whether messages have been sent to the user terminals. Some notifications may be time sensitive and designated by an administrator for delivery at a specific time. These submitted but undelivered notifications may appear on a tracking list as “pending” or “delivery on 12:00 pm.” An administrator can thus look at a sorted list and determine what notifications are sent and which are pending. In addition to tracking sent messages, the administrator interface also receives responses and summarizes their contents. Event RSVPs can be summarized so that management personnel can obtain a tally of attendees. Responses with comments may be flagged to signal to an administrator that the response contains a message. Further functionality will be easily understood by one of ordinary skill in the art and the extent of the administrator interface functions is not limited to those discussed above.

Messages submitted by a building administrator are sent by the administrator interface 13 to the message queue 14. The queue may comprise a number of separate stacks or one single stack. For example there may be separate stacks for messages of different priority levels, or there may be a main stack and a separate stack for time sensitive messages. A variety of queuing methods may be used to handle addition and removal of messages from the stack. A large single stack may be implemented with a priority queue or modified first in first out (FIFO) scheme to facilitate steady handling of messages. Alternatively some separate stacks may be more efficient with last in first out (LIFO) or pure FIFO methods. The type and number of stacks used will depend on the number of building units and network topology. Once a message is received from the administrator terminal, it is placed on the appropriate stack until its turn comes and it is sent to the message routing element.

The message routing element 15 and message dispatch 16 sort notifications and send them to designated user terminals. A list of intended recipients is associated with each notification message. This list is read by the message routing element, which then determines the proper transmission path through the network to the network address of each recipient. Paths may be stored in a routing table for fast lookup, or may be dynamically determined. Because a building generally has a pre-determined number of units, efficiency may dictate the use of routing tables. However, large buildings with regularly changing networks may be better suited to dynamic path assignments. Once a path from the operator terminal to the intended recipient has been assigned to a message, it is sent to message dispatch and then transmitted through the assigned path. The user terminal of an intended recipient will display an indicator screen upon receipt of the notification.

Response messages are handled in a similar fashion to administrator-generated notifications. Users create response messages via a user interface 18 at a user terminal 12 where the message is automatically assigned a path from the user terminal's network address to the operator terminal. After a message is submitted, it is sent to the response queue 17 to wait in line for delivery. The response queue is implemented in a similar manner as the message queue 14 with the type and number of stacks being dependent on the needs of building management. After they leave the queue, messages are sent to the message routing element 15 where the operator terminal path is read. The message routing element then sends the response message to the message dispatch 16, where the message is transmitted to the administrator interface 13. The administrator interface tracks the sender of the response, type of response and flags the message if needed.

Referring now to FIG. 1B, there is shown a block diagram of an alternative implementation of the present event notification system. In lieu of a system management application, this embodiment provides a message-handling server 19 that contains the message queue 14, message routing element 15, message dispatch 16 and response queue 17. Only the administrator interface 13 is installed on the operator terminal 11. Notification messages are generated at the administrator interface and sent through the network to the messaging server, where the messages are placed in a queue. Similarly, response messages are sent from a user terminal to the messaging server, before ultimately being delivered to the operator terminal. This implementation will be useful to companies desiring multiple operator terminals. The addition of multiple operator terminals would permit different building management personnel to send notifications from their own workstations.

In a further alternative embodiment the message handling elements may be implemented on separate servers. Buildings with a large number of units may find it helpful to use several servers to handle the volume of sent and received messages.

In a still further embodiment, the messaging queue and the response queue may be implemented in a single queuing element. This element contains multiple stacks for handling notifications and responses. After messages are processed through the appropriate stack they are sent to the message routing element. This embodiment condenses the queuing elements and therefore is likely to be most useful in a separate servers implementation. However, queue condensing may be integrated into the system management application as well.

All embodiments of the system are implemented on a local area network (LAN). It is closed to the Internet, thereby restricting the ability of unauthorized access to messages. In a preferred embodiment the LAN is wireless (wLAN), but a conventional wired LAN can also be used to implement the system.

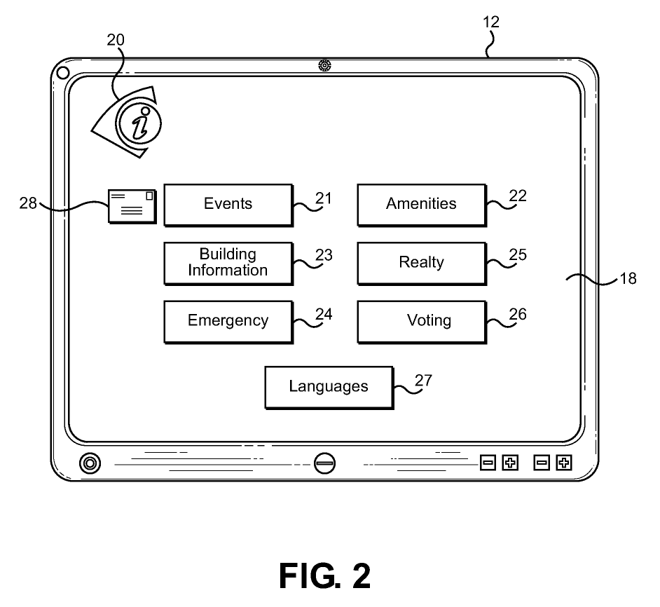

Turning now to FIG. 2, there is shown an example of a welcome screen of the user interface. This screen is displayed when a user initiates the user interface by pressing the touchscreen of the user terminal 12. In an upper portion of the screen a company or building logo 20 may be displayed (here pictured in the upper left). Positioned about the remainder of the screen is a plurality of selectable buttons corresponding to user interface tasks. These tasks include but are not limited to: 1) event notifications 21; 2) amenities 22; 3) building policies 23; 4) emergency information 24; 5) realty options 26; 6) Voting options 26; and 7) language selection 27. When a user presses an area of the touchscreen associated with a selection button, the displayed screen is changed to reflect the selected task. This display change may be abrupt or may include visual transition effects.

If unread notifications are present, an indicator icon 28 is displayed adjacent to a corresponding selection button. In FIG. 2 the icon is displayed next to the event button 21 to indicate that a new event notification has arrived. Alternatively, the selection button may glow or blink to indicate new notifications are available for an associated task.

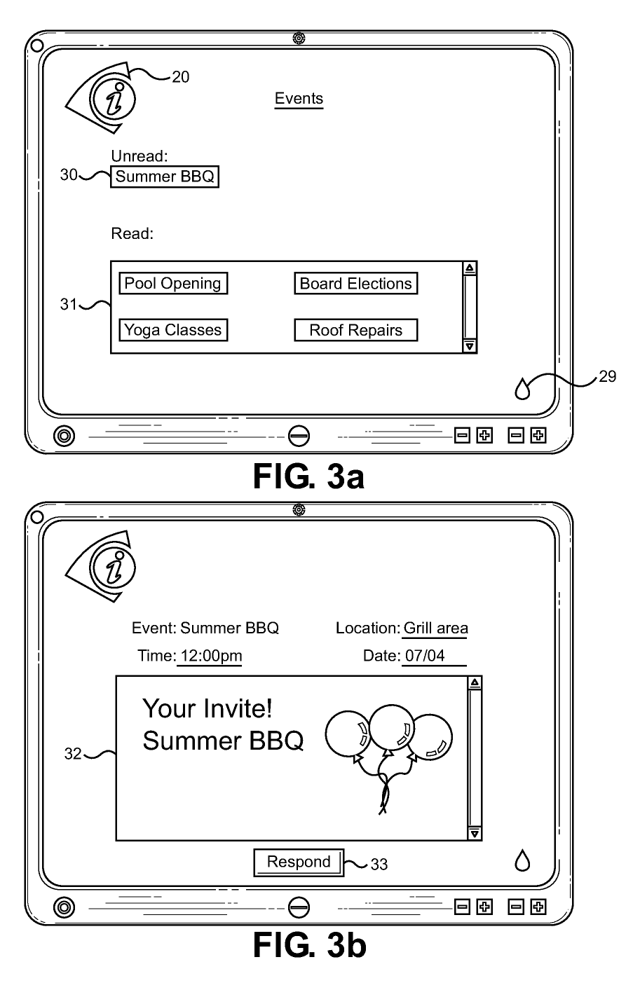

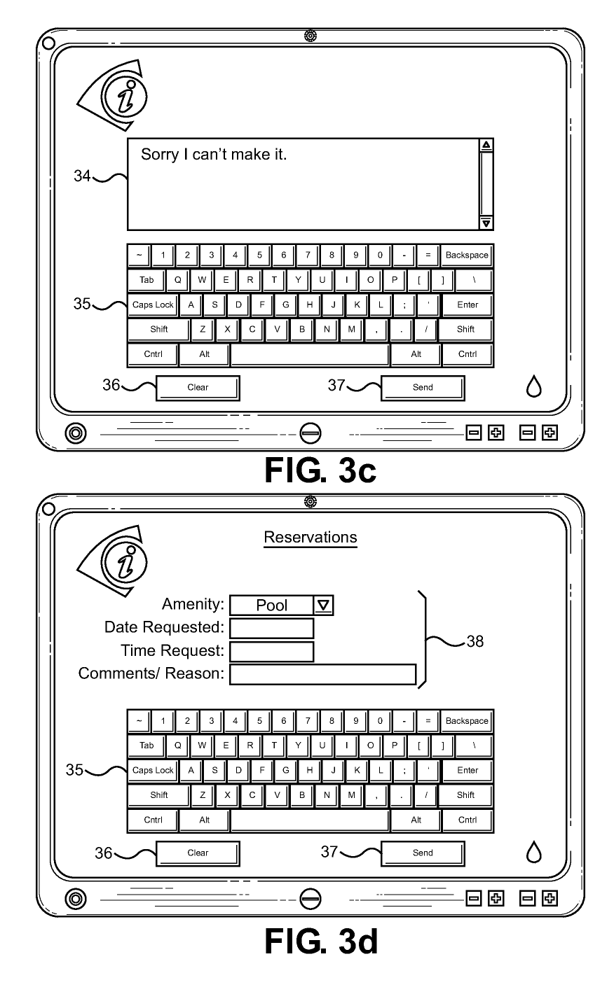

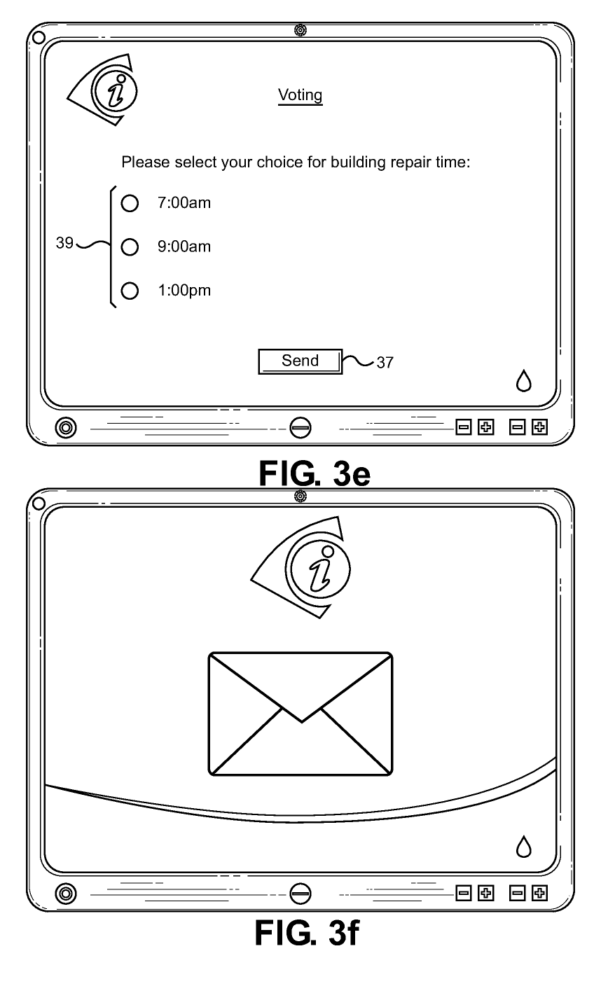

An example of a notification interface for building events is shown in FIG. 3A. A logo 20 is displayed in an upper portion of the screen and a return button 29 is displayed in a lower portion. The return button is displayed in the same position on every task screen and provides a user with an option to return to the welcome screen. In one portion of the screen space is an area for unread notifications. If there are unread notifications for the opened task then a selectable button bearing the subject of the notification 30 will be displayed in the unread section. A text box 31 below the unread notifications section contains a list of previously viewed notices. These notifications are displayed as selectable buttons to allow users to view past messages from building management. Users can scroll through these messages using a scrollbar located on a side of the textbox. Once a user views a notification, it is removed from the unread section and placed within the text box of read messages. If the administrator requested a read-receipt, then one will be sent to the operator terminal.

In FIG. 3B there is shown an example of a notification screen. A plurality of fields displays information about the event such as date, time, and location. If the notification has an attached file, it is opened within a scrolling window 32. A user can click on the window with a finger to enlarge the file into full-screen mode, and click on the screen again to return to the notification screen. Files such as documents, images, slideshow presentations and the like can be viewed at in this manner. Flexibility in file support is important because it allows administrators to create multimedia files that are best suited to the communication. At the bottom of the screen is a selectable response button 33 that takes a user to a response screen when pressed.

An example of a simple response screen is shown in FIG. 3C. A scrolling text field 34 displays the message that will be sent upon submission. Text is entered into the text field via a displayed keyboard 35. By pressing an area of the touchscreen responding to a keyboard key, a user types out the desired message. If a user decides to restart or cancel the message, the clear button 36 is pressed to remove all text from the text field. Once he or she is satisfied with the message displayed in the text field, the send button 37 is pressed to submit the response. Sent responses are transmitted from the user terminal to an operator terminal where they are received by the administrator interface.

Referring now to FIG. 3D, there is shown an example of an amenities reservation request screen. A set of input fields 38 prompt a user to provide information about the type of amenity, time and date requested. A drop down box of reservable building amenities may be used to reduce confusion about what types of facilities can be reserved through the system. Amenities such as a pool, grilling area, recreational areas and the like can be reserved for tenant events. To submit a reservation request, a tenant uses the on-screen keyboard 35 to fill in the input fields with the specified information. The fields may be cleared by pressing the clear button 36 if a user changes his or her mind about event information. After all fields are filled out to the satisfaction of the user, the submit button 37 is pressed to submit the request to the management office. Building management can reply with a confirmation or denial of the request via the event notification system.

In FIG. 3E an example of a voting interface screen is shown, displaying a ballot for preferred time for scheduled maintenance. Tenants can vote on community issues from the comfort of their own unit via the system's voting interface. A ballot provides a user with a voting prompt (issue in question), and a plurality of radio buttons 39. Each radio button is displayed next to an associated voting choice. To vote for a particular choice, a user presses the radio button adjacent to the choice and selects the send button 37. Submitted ballots are transmitted to an operator terminal and tallied by the administrator interface. This allows building management to efficiently obtain community opinion on a given issue. The feature may be especially useful for voting on issues such as election of association members, fees, maintenance and event dates.

Referring now to FIG. 3F there is shown an example of a new notification screen. When new correspondence arrives, the user terminal screen automatically illuminates and displays the new notification screen. A prominent icon is displayed to indicate to tenants that new communications have arrived. Optionally an indicator light on the user terminal also illuminates. If a user does not touch the screen within a pre-determined period of time, the user terminal will return to a “sleep” mode to save energy.

Other features of the user interface include building information and community policies, emergency information, realty options and language selection. Though not displayed here these options should be understood as being implemented in a manner consistent with the tasks discussed above. The building information and community policies task provides a user with a list of selectable buttons. These buttons are associated with documents of building policies and general information. The emergency information task provides tenants with current emergency information and a list of selectable buttons associated with emergency maps. When the realty options task is selected, a user can browse a list of selectable notifications regarding available property in the complex. It also permits a user to create a property listing and submit the listing to building management for posting on the realty options list. The language selection task provides a single screen with a set of radio buttons associated with several languages. A user may change the language of the user interface by selecting a radio button associated with the desired language. The user interface is not limited to these tasks and it should be understood by one of ordinary skill in the art that tasks may be removed, or additional tasks added to further increase the functionality of the system.

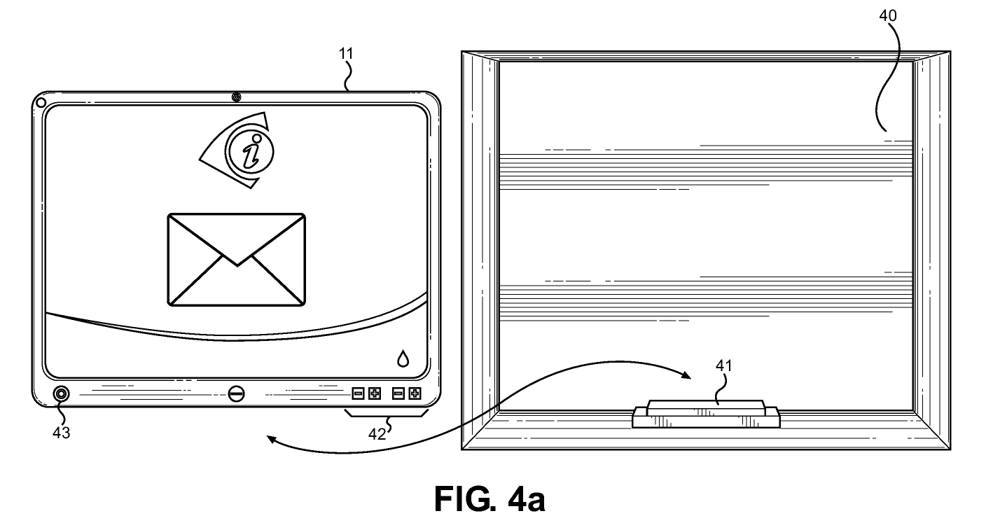

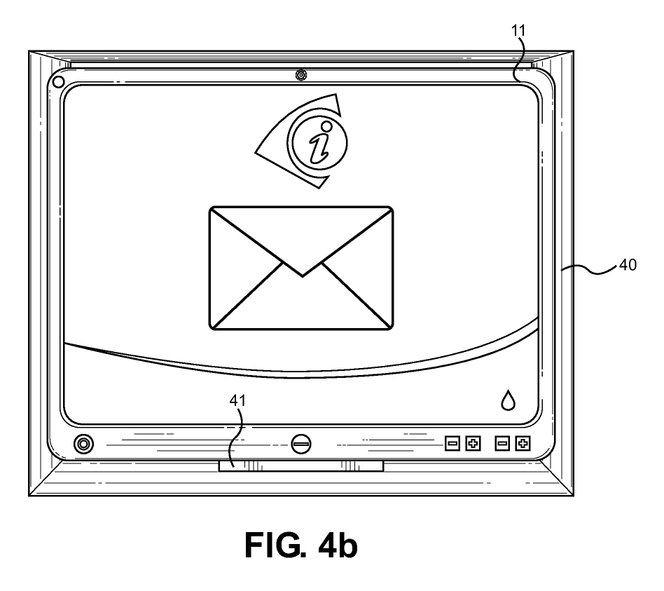

Turning now to FIG. 4A, there is shown a perspective view of the user terminal 11 removed from a docking recess 40. The user terminal is preferably a portable computing device having a storage media and network connection capability, so that users may access the notification system anywhere within the unit. A touch screen is associated with the portable computing device to reduce the need for ancillary input peripherals that can become lost or damaged. The user terminal is therefore lightweight, compact and convenient for building tenants to hold and operate.

Along an edge of the user terminal there is a plurality of buttons 42 that manipulate display settings of the user terminal. These buttons allow a user to toggle settings such as brightness, contrast and volume. A power button 43 is also disposed along an edge of the user terminal so that the device may be turned off to conserve power. If the device is left on and does not receive user interaction for a pre-determined period of time, the user terminal will enter a “sleep” state to reduce power drain on the device battery. Either the receipt of a new message or user interaction with the device will “wake” the user terminal.

In FIG. 4B there is shown a front view of a user terminal within a docking recess. A docking recess 40 is disposed along the wall in each building unit to provide a removable mounting for the user terminal, 11 where it is protected and recharged when not in use. The recess has four sidewalls and a rear wall defining an interior space. Along one wall of the recess is a docking station 41 adapted to operatively connect to the docking port (not shown) of a user terminal. The docking station is electrically connected to an AC power outlet within the wall. When a tenant is not using the user terminal, he or she places the docking port over the docking station and gently presses the terminal into position. While the device is docked, the terminal's internal battery will recharge so that the device is ready for use whenever a tenant wants to send a message.

In an alternative embodiment the user terminal is permanently mounted to the wall of a unit. A tenant can interact with the touch screen of the user terminal to access the notification system. However, the tenant cannot move about the unit with the user terminal. This embodiment may be advantageous to residential communities with regular turnaround of occupants, to reduce loss or damage of system equipment during moving situations.

In use a tenant touches the screen of the user terminal to access the welcome screen. He or she can remove the terminal from the docking recess and carry it to a comfortable location such as a living room, bedroom or any other location in the unit. A visual indication is provided to the user if new correspondence has arrived for a particular task. The user then touches the screen over the displayed task button to proceed to unread messages. The notification can be read in full-screen or windowed mode, according to a user's preference. If the tenant user decides to reply to the notification, he or she may do so by using the touch screen to enter text at a reply screen, then pressing send. The reply will be received by building management and flagged for reading.

The system management software is ideal for small to medium sized buildings and complexes, because it provides a simple compact implementation that does not require extraneous hardware and network configuration. These things generally require setup and maintenance by information technology professionals, and therefore may not be a cost effective solution for smaller buildings. The present event notification system solves this problem by incorporating message handling within a single system management application. Alternatively the system also provides a scalable and robust, multi-server notification system that can be adapted to the more complex networks of large buildings and complexes.

The system preferably includes a user terminal in every dwelling or commercial unit within a building so that all potential tenants have access to notifications. These user terminals have user interface software that is easy to navigate and use. Tenants can access a variety of functional tasks including but not limited to: 1) events; 2) building policies; 3) amenities reservations requests; 4) emergency information; 5) realty information; 6) voting; and 7) language options. Tasks can be accessed and used via the touch screen display of the user terminal. Some tasks are merely informatory, while others provide tenants with a means to send messages, comments and requests to building management. Thus, the system provides building managers with a time efficient, low paper waste, option for communicating with tenants.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) An event notification system for a residential or commercial building, comprising:
an operator terminal;
a plurality of user terminals having touchscreen input means;
a data network connecting said operator terminal to said plurality of user terminals;
a system management application running on said operator terminal and including an administrator interface component and a plurality of message handling elements, wherein said administrator interface is capable of generating electronic messages that are routed by said message handling elements, and sent to said user terminals;
a user interface running on each of said user terminals, capable of receiving and storing notification messages, and navigable via said touch screen input means;
a notification indicator screen that is displayed by said user terminal whenever unread messages are received;
a welcome screen providing a user with a plurality of selectable tasks;
at least one response screen that prompts a user to input a response to a notification then instructs said user interface to generate a response message, wherein said response message is routed is by said message handling elements, and sent to said administrator interface.

2) The system of claim 1, wherein said message handling elements includes a message queue.

3) The system of claim 1, wherein said message handling elements includes a message routing element.

4) The system of claim 1, wherein said message handling elements includes a message dispatcher.

5) The system of claim 1, wherein said message handling elements includes a response queue.

6) The system of claim 1, wherein said task options include at least one of events, building policies, emergency information, amenities reservation, realty options, voting, and language selection.

7) The system of claim 1, wherein said administrator interface receives a read receipt after a user views a notification.

8) The system of claim 1, wherein said noisier interface is capable of displaying multimedia files associated with said notification messages.

9) The system of claim 1, further comprising:
a docking station disposed on a wall and electrically connected to an AC power source, and adapted to receive and electrically connect to a user terminal.

10) An event notification system for residential or commercial buildings, comprising:
an operator terminal having an administrator interface component;
a plurality of user terminals having touchscreen input means;
a data network connecting said operator terminal to said plurality of user terminals;
at least one server running at least one message handling element, and wherein said administrator interface is capable of generating electronic messages that are routed by said at least one server running a message handling element, and sent to said user terminals;
a user interface running on each of said user terminals, capable of receiving and storing notification messages, and navigable via said touch screen input means;
a notification indicator screen that is displayed by said user terminal whenever unread messages are received;
a welcome screen providing a user with a plurality of selectable tasks;
at least one response screen that prompts a user to input a response to a notification then instructs said user interface to generate a response message, wherein said response message is routed is by said message handling elements, and sent to said administrator interface.

11) The system of claim 10, wherein said message handling elements includes a message queue.

12) The system of claim 10, wherein said message handling elements includes a message routing element.

13) The system of claim 10, wherein said message handling elements includes a message dispatcher.

14) The system of claim 10, wherein said message handling elements includes a response queue.

15) The system of claim 10, wherein said task options include at least one of events, building policies, emergency information, amenities reservation, realty options, voting, and language selection.

16) The system of claim 10, wherein said administrator interface receives a read receipt after a user views a notification.

17) The system of claim 10, wherein said noisier interface is capable of displaying multimedia files associated with said notification messages.

18) The system of claim 10, further comprising:
a docking station disposed on a wall and electrically connected to an AC power source, and adapted to receive and electrically connect to a user terminal.
